(19) United States
(12) Patent Application Publication
(10) Pub. No.: US 2011/0279444 A1
(43) Pub. Date: Nov. 17, 2011

(54) DISPLAY DEVICE TO COMPENSATE CHARACTERISTIC DEVIATION OF DRVING TRANSISTOR AND DRIVING METHOD THEREOF

(75) Inventors: Ho-Ryun Chung, Yongin-City (KR); Choon-Yul Oh, Yongin-city (KR); Naoaki Komiya, Yongin-city (KR); Myoung-Hwan Yoo, Yongin-city (KR); Joo-Hyeon Jeong, Yongin-city (KR); Chang-Ho Hyun, Yongin-city (KR); Woung Kim, Yongin-city (KR); Wang-Jo Lee, Yongin-city (KR); In-Ho Choi, Yongin-city (KR)

(73) Assignee: Samsung Mobile Display Co., Ltd., Yongin-City (KR)

(21) Appl. No.: 12/914,219

(22) Filed: Oct. 28, 2010

(30) Foreign Application Priority Data
May 12, 2010 (KR) 10-2010-0044587

(51) Int. Cl. G06F 3/038

(52) U.S. Cl. 345/214

(57) ABSTRACT

A display device includes a display having a plurality of pixels, a compensator that for each of a plurality of pixels, calculates an image data compensation amount that compensates a characteristic deviation of a driving transistor of each pixel by measuring the first pixel current generated by the first data voltage and the second pixel current generated by the second data voltage obtained by amending the first data voltage, and initializes a panel capacitor that is parasitic on a plurality of data lines connected to the plurality of pixels in the measurement of the first pixel current and the measurement of the second pixel current; and a signal controller that generates an image data signal by reflecting the compensation amount of the image data. It is possible to shorten a compensation period for compensating a characteristic deviation between driving transistors, and since a data writing period in which a data signal is written in each pixel and a light emitting period in which, after the writing of the data signal corresponding to each pixel is completed, the entire pixel emits light at once, making it possible to more efficiently display the image.

### CROSS-REFERENCE TO RELATED APPLICATION

This application claims the benefit of Korean Patent Application No. 10-2010-0044587, filed on May 12, 2010, in the Korean Intellectual Property Office, the disclosure of which is incorporated herein by reference.

### BACKGROUND

1. Field

An aspect of the present invention relates to a display device and a method for driving the same. More particularly, an aspect of the present invention relates to a display device that compensates a characteristic deviation of a driving transistor and a driving method thereof.

2. Description of the Related Art

Currently, various flat panel displays having reduced weight and volume compared to cathode ray tubes have been developed. Types of flat panel displays, include a liquid crystal display (LCD), a field emission display, a plasma display panel (PDP) and an organic light emitting diode OLED.

Among the flat panel displays, the organic light emitting diode OLED display displays an image by using an organic light emitting diode OLED generating light by recombining electrons and holes, and the OLED display is advantageous over other flat panel displays because of its rapid response speed, and the low power consumption need to drive it. Furthermore, the OLED display has excellent luminance and viewing angle.

The organic light emitting diode OLED display is classified into a passive matrix OLED (PMOLED) and an active matrix OLED (AMOLED) according to the driving method of the organic light emitting diode.

Among them, in views of resolution, contrast, and operation speed, the AMOLED that is selectively turned on for every unit pixel is mainly used.

One pixel of the active matrix OLED includes the organic light emitting diode OLED, a driving transistor that controls a current amount that is supplied to the organic light emitting diode OLED, and a switching transistor that transmits the data signal that controls the light emitting amount of the organic light emitting diode OLED to the driving transistor.

In order to allow the organic light emitting diode OLED to emit light, the driving transistor should be continuously turned-on. In the case of the large panel, there is a characteristic deviation between the driving transistors, and mura occurs because of the characteristic deviation. The characteristic deviation of the driving transistor represents the threshold voltage and mobility deviation between a plurality of driving transistors that form the large panel. Even though the same data voltage is transmitted to the gate electrode of the driving transistor, currents that flow through the driving transistor are different according to the characteristic deviation between a plurality of driving transistors.

Therefore, since there are problems in that the image quality characteristic is deteriorated, there is a need for compensating and improving it.

The above information disclosed in this Background section is only for enhancement of understanding of the background of the invention and therefore it may contain information that does not form the prior art that is already known in this country to a person of ordinary skill in the art.

### SUMMARY

An aspect of the present invention has been made in an effort to provide a display device having advantages of efficiently compensating a characteristic deviation of a driving transistor and a driving method thereof.

An exemplary embodiment of the present invention provides a display device having a display that includes a plurality of pixels, a compensator that for each of a plurality of pixels, generates a compensation image data signal that compensates a characteristic deviation of a driving transistor of each pixel by measuring the first pixel current generated by the first data voltage and the second pixel current generated by the second data voltage obtained by amending the first data voltage, and initializing a panel capacitor that is parasitic on a plurality of data lines that are connected to the plurality of pixels in the measurement of the first pixel current and the measurement of the second pixel current; and a signal controller that generates an image data signal by reflecting a compensation amount of the image data signal.

The compensator may include a measurement portion that measures each pixel current of the plurality of pixels; a target portion for removing noise that is generated at the measurement portion; a comparison portion that compares output values of the measurement portion and the target portion; a SAR (Successive Approximation Register) logic that calculates the image data compensation amount from the output value of the comparison portion; and a converter that converts the output value of the SAR logic to the analog value and transmits the values to the plurality of pixels.

The measurement portion may include a measurement resistor that converts each pixel current of the plurality of pixels into a measurement voltage; a differential amplifier that outputs a difference between a predetermined test data voltage and the measurement voltage; and a reset switch that is connected to the measurement resistor in parallel to initialize the panel capacitor.

The differential amplifier may include a non-inversion input terminal to which the predetermined test data voltage is inputted; an inversion input terminal that is connected to the plurality of data lines; and an output terminal that outputs a difference between the predetermined test data voltage and the measurement voltage.

The reset switch may include an end that is connected to the output terminal of the differential amplifier; and the other end that is connected to the plurality of data lines.

The measurement resistor may include an end that is connected to the output terminal of the differential amplifier; and the other end that is connected to the plurality of data lines.

The reset switch is turned on before the pixel current is measured, such that the differential amplifier may become a source follower.

The compensator charges the panel capacitor with the predetermined test data voltage by turning on the reset switch, thus performing initialization.

The target portion is connected to the reference pixel that has a predetermined reference threshold voltage and reference mobility to obtain the same configuration as the measurement portion.

The comparison portion may include a non-inversion input terminal to which the output voltage of the measurement portion is inputted; an inversion input terminal to which the output voltage of the target portion is inputted; and a differential amplifier that includes an output terminal that outputs a difference between the output voltage of the measurement portion and the output voltage of the target portion.

The display device may further include a data selector that includes a first selection switch that connects the plurality of pixels to the converter; and a second selection switch that connects the plurality of pixels to the measurement portion.

Another embodiment of the present invention provides a driving method of a display device, the method includes initializing a panel capacitor that charges a panel capacitor that is parasitic on a data line that is connected to the pixel by the test data voltage; generating a first pixel current by applying a first data voltage to the pixel; measuring the first pixel current by changing the first pixel current to the measurement voltage; and generating a second pixel current by applying a second data voltage, compensating a characteristic deviation of the driving transistor of the pixel, that is obtained by modifying the first data voltage to the pixel; and measuring the second pixel current by changing the second pixel current to the measurement voltage.

The driving method of a display device may further include after the second pixel current is measured, generating a compensation image data signal that compensates the characteristic deviation of the driving transistor of the pixel.

The driving method of a display device may further include transmitting a data voltage selected according to the compensation image data signal to the pixel.

The driving method of a display device may further include charging the panel capacitor with the test data voltage before the second pixel current is generated.

The generating the first pixel current may include turning on the first selection switch to connect a converter to which the first data voltage is outputted and the pixel; and turning off the second selection switch to connect a measuring portion that measures the first pixel current and the pixel.

The generating of the first pixel current may include turning off the first selection switch to connect the converter to which the first data voltage is outputted and the pixel; and turning on the second selection switch to connect a measuring portion that measures the first pixel current and the pixel.

The panel capacitor is connected to the output terminal of a differential amplifier to which the test data voltage is inputted, and the initializing panel capacitor makes the differential amplifier as a source follower by turning on the reset switch that is connected in parallel to a measurement resistor that converts the first pixel current into the measurement voltage.

The reset switch is kept turned off when measuring the first pixel current and when measuring the second pixel current.

According to the embodiments of the present invention, it is possible to shorten a compensation period for compensating a characteristic deviation between driving transistors, and since a data writing period in which a data signal is written in each pixel and a light emitting period in which, after the writing of the data signal corresponding to each pixel is completed, the entire pixel emits light at once, it is possible to more efficiently display the image.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an organic light emitting diode OLED display according to an embodiment of the present invention;

FIG. 2 is a circuit diagram that illustrates a pixel according to an embodiment of the present invention;

FIG. 3 is a circuit diagram that illustrates a compensator according to an embodiment of the present invention; and

FIG. 4 is a timing diagram of an organic light emitting diode OLED display according to an embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

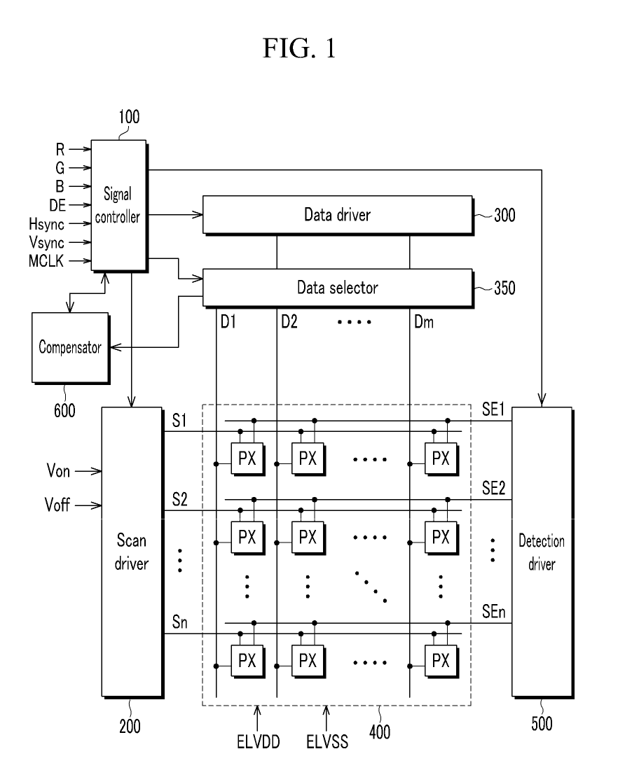

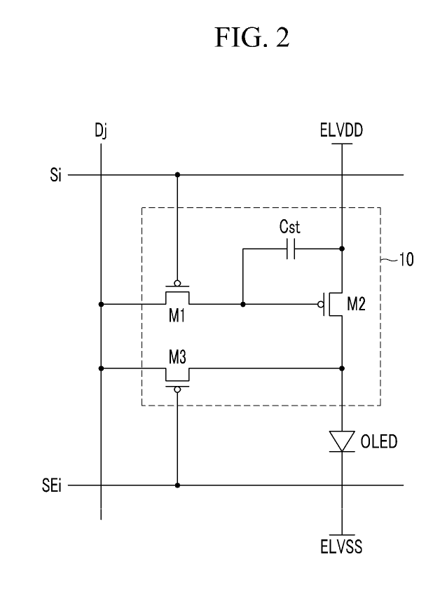

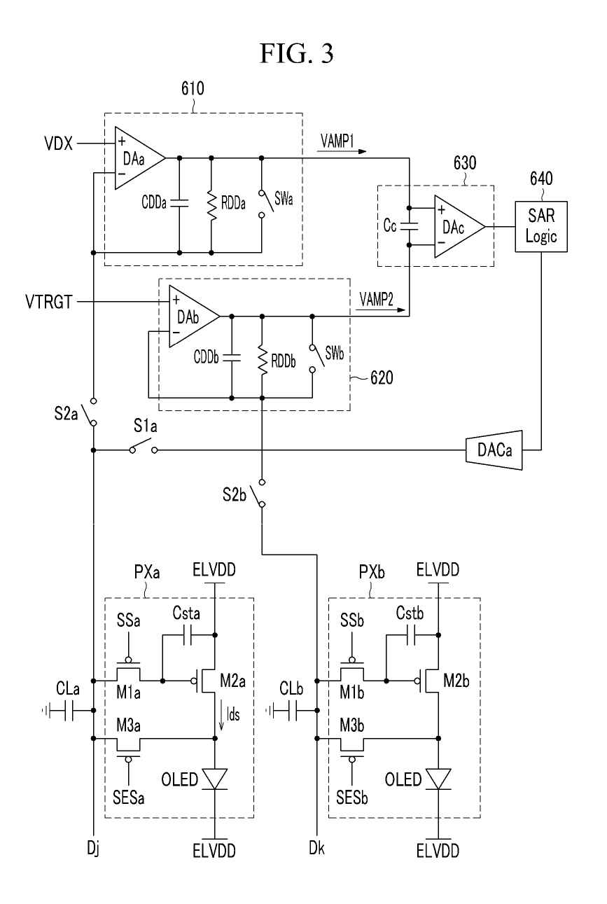

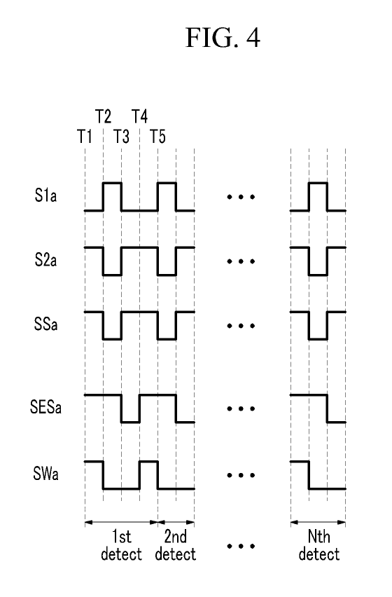

FIG. 1 is a block diagram of an organic light emitting diode OLED display according to an embodiment of the present invention. FIG. 2 is a circuit diagram that illustrates a pixel according to an embodiment of the present invention. FIG. 3 is a circuit diagram that illustrates a compensator according to an embodiment of the present invention. FIG. 4 is a timing diagram of an organic light emitting diode OLED display according to an embodiment of the present invention.

Referring to FIG. 1, the organic light emitting diode OLED display includes a signal controller 100, a scan driver 200, a data driver 300, a data selector 350, a display 400, a detection driver 500 and compensator 600.

The signal controller 100 receives a video signal R, G, B that is inputted from an external device and an input control signal that controls displaying thereof. The video signal R, G, B includes luminance of each pixel PX, and the luminance has a grayscale having a predetermined number, for example, 1024=2¹⁰, 256=2⁸ or 64=2⁶. As examples of the input control signal, there are vertical synchronization signal Vsync, horizontal synchronization signal Hsync, main clock MCLK, and data enable signal DE.

The signal controller 100 appropriately process the input video signal R, G, B according to the operation condition of the display 400 and data driver 300 on the basis of the input video signal R, G, B and the input control signal, and generates scan control signal CONT1, data control signal CONT2, image data signal DAT and monitor control signal CONT3. The signal controller 100 transmits the scan control signal CONT1 to the scan driver 200. The signal controller 100 transmits the data control signal CONT2 and image data signal DAT to the data driver 300. The signal controller 100 transmits the monitor control signal CONT3 to the detection driver 500. The signal controller 100 controls an operation of a selection switch (see S1a, S2a, S2b of FIG. 3) by transmitting the selection signal to the data selection portion or date selector 350.

The display 400 includes a plurality of scan line S1-Sn, a plurality of data line D1-Dm, a plurality of detection lines SE1-SEn and a plurality of pixels PX that are connected to a plurality of signal lines S1-Sn, D1-Dm, SE1-SEn and arranged in a matrix form. A plurality of scan lines S1-Sn and a plurality of detection lines SE1-SEn extend in an approximately row direction and almost are parallel to each other, and a plurality of data lines D1-Dm extend in an approximately column direction and almost are parallel to each other. A plurality of pixels PX of the display 400 receive the first power source voltage ELVDD and the second power source voltage ELVSS from an external unit (not shown).

The scan driver 200 is connected to a plurality of scan lines S1-Sn, and applies scan signal that includes a combination of gate on voltage Von that turns on the switching transistor (see M1 of FIG. 2 according to the scan control signal CONT1) and a gate off voltage Voff that turns off the switching transistor.

The data driver 300 is connected to a plurality of data lines D1-Dm, and selects a data voltage according to the image data signal DAT. The data driver 300 applies the selected data voltage as the data signal to a plurality of data lines D1-Dm according to the data control signal CONT2.

The data selector 350 is connected to a plurality of data lines D1-Dm, and includes selection switches (see S1a, S2a, S2b of FIG. 3) that are connected to a plurality of data lines D1-Dm, respectively. The data selector 350 responds to the selection signal that is transmitted from the signal controller 100 to control the selection switch, such that the data selector 350 transmits the data signal to a plurality of pixels PX or transmits the pixel current that is generated in the pixel PX to the compensator 600.

The detection driver 500 is connected to a plurality of detection lines SE1-SEn, and applies the detection scan signal that turns on or turns off the detection transistor (see M3 of FIG. 2 according to the detection control signal CONT3) to a plurality of detection lines SE1-SEn.

The compensator 600 calculates the image data compensation amount that can compensate the characteristic deviation of the driving transistor of the pixel by receiving the pixel current. The compensator 600 transmits the calculated image data compensation amount to the signal controller 100, and the signal controller 100 generates the image data signal DAT in response to the image data compensation amount. A detailed description thereof will be described below.

Referring to FIG. 2, a pixel PX of the organic light emitting diode OLED display includes the organic light emitting diode OLED and the pixel circuit 10 for controlling the organic light emitting diode OLED. The pixel circuit 10 includes the switching transistor M1, the driving transistor M2, detection transistor M3 and sustain capacitor Cst.

The switching transistor M1 includes the gate electrode that is connected to the scan line Si, an end that is connected to the data line Dj, and the other end that is connected to the gate electrode of the driving transistor M2.

The driving transistor M2 includes the gate electrode that is connected to the other end of the switching transistor M1, an end that is connected to the ELVDD power source, and the other end that is connected to the anode electrode of the organic light emitting diode OLED.

The sustain capacitor Cst includes an end that is connected to the gate electrode of the driving transistor M2 and the other end that is connected to the ELVDD power source. The sustain capacitor Cst charges the data voltage that is applied to the gate electrode of the driving transistor M2 and maintains it after the switching transistor M1 is turned off.

The detection transistor M3 includes the gate electrode that is connected to the detection line SEi, an end that is connected to the other end of the driving transistor M2 and the other end that is connected to the data line Dj.

The organic light emitting diode OLED includes the anode electrode that is connected to the other end of the driving transistor M2 and the cathode electrode that is connected to the ELVSS power source.

The switching transistor M1, driving transistor M2 and detection transistor M3 may be a p-channel field effect transistor. In this case, the gate on voltage that turns on the switching transistor M1, driving transistor M2 and detection transistor M3 is a logic low level voltage, and the gate off voltage that turns off them is a logic high level voltage.

Here, the p-channel field effect transistor is show, but at least one of the switching transistor M1, driving transistor M2 and detection transistor M3 may be a n-channel field effect transistor, and In this case, the gate on voltage that turns on the n-channel field effect transistor is the logic high level voltage and the gate off voltage that turns off it is the logic low level voltage.

If the gate on voltage Von is applied to the scan line Si, the switching transistor M1 is turned on, the data signal that is applied to the data line Dj is applied to an end of the sustain capacitor Cst through the turned on switching transistor M1 to charge the sustain capacitor Cst. The driving transistor M2 controls the current amount that flows from the ELVDD power source to the organic light emitting diode OLED by corresponding to the voltage value that is charged in the sustain capacitor Cst. The organic light emitting diode OLED emits light that corresponds to the current amount that flows through the driving transistor M2. In this case, to the detection line SEi, the gate off voltage is applied, the detection transistor M3 is turned off, and the current that flows through the driving transistor M2 does not flow through the detection transistor M3.

The organic light emitting diode OLED can emit one light of primary colors. As examples of the primary colors, there may be three primary colors of red, green and blue, and a desired color is displayed by spatial and temporal sum of these three primary colors. In this case, a portion of the organic light emitting diode OLED can emit white light, and if this is performed, the luminance is increased. Unlike this, an organic light emitting diodes OLED of all the pixels PX can emit white light, and a portion of the pixels PX may further include a color filter (not shown) that converts the white light that is emitted from the organic light emitting diode OLED into any one of the primary colors.

Each of the driving apparatuses 100, 200, 300, 350, 500, 600 are directly mounted on the display 400 in at least one integrated circuit chip form, mounted on the flexible printed circuit film, attached to the display 400 in a TCP (tape carrier package) form, mounted on the separate flexible printed circuit FPC, or integrated on the display 400 in conjunction with the signal lines S1-Sn, D1-Dm, SE1-SEn.

It is assumed that the organic light emitting diode OLED display according to an aspect of the present invention is driven according to the frame that includes the compensation period that detects the characteristic of the driving transistor of each pixel and compensates the characteristic deviation, data writing period in which the data signal is transmitted to each pixel and written, and the light emitting period in which after the writing of the data signal that corresponds to each pixel is completed, the entire pixel emits light at once. The compensation period is not included in every frame but is included according to a predetermined number of frames, such that the characteristic deviation compensation of the driving transistor of each pixel is performed. In addition, according to an aspect of the present invention, a sequential driving method in which light is emitted in each of pixels if the data writing period is finished may be performed.

Referring to FIG. 3, the compensator 600 includes a measurement unit 610 that measures the pixel current of the measurement pixel PXa, a target portion 620 that removes noise that is generated in the measurement unit 610, a comparison portion 630 that compares the output values of the measurement unit 610 and the target portion 620, a SAR (Successive Approximation Register) logic 640 that treats the output value of the comparison portion 630 and a converter DACa that converts the output value of the SAR logic 640 into the analog value and transmits the analog value to the measurement pixel PXa.

The first selection switch S1a and the second selection switch S2a are connected to the data line Dj of the measurement pixel PXa. The measurement pixel PXa is connected to the converter DACa by the first selection switch S1a, and connected to the measurement unit 610 by the second selection switch S2a.

The third selection switch S2b is connected to the data line Dk of the reference pixel PXb. The reference pixel PXb is connected to the target portion 620 by the third selection switch S2b.

The measurement pixel PXa is a target pixel that measures the characteristic deviation of the driving transistor, and represents a plurality of pixels that are included in the display 400. The reference pixel PXb represents the pixel that is the measurement reference in respects to the measurement pixel PXa. The reference pixel PXb is the pixel that has the predetermined reference threshold voltage and reference mobility, and any one of a plurality of pixels that are included in the display 400, or the pixel that is separately provided for compensating the characteristic deviation of the driving transistor. The reference pixel PXb is a dummy pixel in which the data voltage is not written according to video signal, and the threshold voltage and mobility when the manufacturing is finished are not changed.

During the compensation period, the ELVDD voltage may be applied to the cathode electrode of the organic light emitting diode OLED of the measurement pixel PXa and reference pixel PXb. Then, during the compensation period, the current does not flow through the organic light emitting diode OLED.

The first panel capacitor CLa is connected to the data line Dj that is connected to the measurement pixel PXa, and the second panel capacitor CLb is connected to the data line Dk that is connected to the reference pixel PXb. The first panel capacitor CLa and the second panel capacitor CLb include an end that is connected to the data line and the other end that is connected to the conductive wire that is grounded. The panel capacitor may be connected to each of a plurality of data lines D1-Dm that are included in the display 400. This illustrates in a circuit form a capacitance that is parasitic on each data line.

The measurement unit 610 includes the first differential amplifier DAa, the measurement capacitor CDDa, measurement resistor RDDa and the first reset switch SWa.

The first differential amplifier DAa includes a non-inversion input terminal (+) to which a predetermined test data voltage VDX is inputted, an inversion input terminal (−) that is connected to the data line Dj of the measurement pixel PXa, and an output terminal that is connected to the comparison portion 630.

The measurement capacitor CDDa includes an end that is connected to the output terminal of the first differential amplifier DAa, and the other end that is connected to the data line Dj of the measurement pixel PXa. The measurement resistor RDDa includes an end that is connected to the output terminal of the first differential amplifier DAa, and the other end that is connected to the data line Dj of the measurement pixel PXa. The first reset switch SWa includes an end that is connected to the output terminal of the first differential amplifier DAa, and the other end that is connected to the data line Dj of the measurement pixel PXa.

The measurement capacitor CDDa, measurement resistor RDDa and the first reset switch SWa are connected to each other in parallel. If the first reset switch SWa is turned on, the output terminal of the first differential amplifier DAa and the inversion input terminal (−) are connected to become the source follower. In this case, since the output terminal of the first differential amplifier DAa is connected to an end of the first panel capacitor CLa, the first panel capacitor CLa is charged by the output terminal voltage of the first differential amplifier DAa.

The pixel current Ids that flows in the measurement pixel PXa passes through the measurement resistor RDDa and is inputted to the inversion input terminal (−) of the measurement unit 610, and the measurement unit 610 outputs the voltage that corresponds to a voltage difference that is changed according to the test data voltage VDX, the measurement resistor RDDa * pixel current Ids. In this case, if a difference between the output voltage of the measurement unit 610 and the voltages that are charged to the first panel capacitor CLa is large, the time for charging the panel capacitor CLa is increased. Then, the measurement time of the pixel current Ids is increased.

In an exemplary embodiment of the present invention, before the pixel current Ids is measured, the first reset switch SWa is turned on. Then, the first differential amplifier DAa becomes the source follower, such that the panel capacitor CLa is charged by the test data voltage VDX of the inversion terminal (+) of the first differential amplifier DAa. This is called the initialization operation of the panel capacitor CLa.

The target portion 620 includes the second differential amplifier DAb, the target capacitor CDDb, target resistor RDDb and the second reset switch SWb. The target portion 620 is connected to the reference pixel PXb that has the predetermined reference threshold voltage and reference mobility and has the same configuration as the measurement unit 610, thus generating the same noise as that generated in the measurement unit 610. The noise that is generated in the target portion 620 is transmitted to the inversion input terminal (−) of the comparison portion 630 and can offset the noise that is inputted to the non-inversion input terminal (+) and is included in the output of the measurement unit 610.

The second differential amplifier DAb includes a non-inversion input terminal (+) to which target voltage VTRGT is inputted, an inversion input terminal (−) that is connected to the data line Dk of the reference pixel PXb, and an output terminal that is connected to the comparison portion 630.

The target capacitor CDDb includes an end that is connected to the output terminal of the second differential amplifier DAb, and the other end that is connected to the data line Dj of the reference pixel PXb. The target resistor RDDb includes an end that is connected to the output terminal of the second differential amplifier DAb, and the other end that is connected to the data line Dk of the reference pixel PXb. The second reset switch SWb includes an end that is connected to the output terminal of the second differential amplifier DAb, and the other end that is connected to the data link Dk of the reference pixel PXb.

The test data voltage VDX is the reference value that has a difference in respects to the measurement voltage that is generated when the pixel current of the measurement pixel PXa flows through the measurement resistor RDDa, and the target voltage VTRGT is a target value of a difference between the measurement voltage and the test data voltage VDX.

The measurement unit 610 converts the current that is generated in the measurement pixel PXa into the measurement voltage, and amplifies a difference between the test data voltage VDX and the measurement voltage, thus outputting it to the first amplification voltage VAMP1. The target portion 620 is connected to the reference pixel PXb and generates the same noise as the noise that is generated in the measurement unit 610, and amplifies the target voltage VTRGT that includes the noise, thus outputting it to the second amplification voltage VAMP2. The output voltage of the first differential amplifier DAa is called the first amplification voltage VAMP1, and the output voltage of the second differential amplifier DAb is called the second amplification voltage VAMP2.

The comparison portion 630 includes the third differential amplifier DAc and the comparative capacitor Cc.

The third differential amplifier DAc the non-inversion input terminal (+) that is connected to the output terminal of the first differential amplifier (DAa, the inversion input terminal (−) that is connected to the output terminal of the second differential amplifier DAb, and the output terminal that is connected to the SAR logic 640. The comparative capacitor Cc includes an end that is connected to the output terminal of the first differential amplifier DAa and the other end connected to the output terminal of the second differential amplifier DAb.

The comparison portion 630 amplifies a difference between the first amplification voltage VAMP1 of the measurement portion 610 and the second amplification voltage VAMP2 of the target portion 620 and transmits the difference to the SAR logic 640. The difference between the first amplification voltage VAMP1 and the second amplification voltage VAMP2 is a value that is obtained by removing noise that is generated in the measurement unit 610 by a characteristic deviation of the driving transistor M2a of the measurement pixel PXa.

The SAR logic 640 is connected to the output terminal of the third differential amplifier DAc and the converter DACa. The SAR logic 640 generates an image data compensation amount in respects to the measurement pixel PXa and a compensation image data signal that is reflected by the image data compensation amount. The SAR logic 640 generates the compensation image data signal in a direction that lowers a difference between the first amplification voltage VAMP1 and the second amplification voltage VAMP2.

First, the converter DACa applies the first data voltage that is the same as the test data voltage VDX to the measurement pixel PXa. The first amplification voltage VAMP1 that is reflected by the first pixel current Ids that is generated in the measurement pixel PXa is generated in the measurement unit 610 and outputted.

The comparison portion 630 compares the second amplification voltage VAMP2 outputted from the target portion 620 and the first amplification voltage VAMP1 outputted by the measurement unit 610. This is called the measurement of the first pixel current.

The first data voltage may be data voltage that shows a predetermined grayscale for compensating the characteristic deviation of the driving transistor M2a of the measurement pixel PXa. For example, the first data voltage may be the data voltage that shows the grayscale of the highest level, or the data voltage that shows the grayscale of the lowermost level.

If a difference between the first amplification voltage VAMP1 and the second amplification voltage VAMP2 in the measurement of the first pixel current is measured, the SAR logic 640 applies the second data voltage to the measurement pixel PXa so as not to generate a difference between the first amplification voltage VAMP1 and the second amplification voltage VAMP2. The SAR logic 640 compares the first amplification voltage VAMP1 and the second amplification voltage VAMP2 that reflects the second pixel current that is generated in the measurement pixel PXa. This is called the measurement of the second pixel current.

The second data voltage is determined by a difference value between the first amplification voltage VAMP1 and the second amplification voltage VAMP2. That is, the second data voltage is selected in a direction that reduces a difference between the first amplification voltage VAMP1 and the second amplification voltage VAMP2. For example, in the measurement of the first pixel current, if the first amplification voltage VAMP1 is outputted so as to be larger than the second amplification voltage VAMP2 by 0.1 V, the second data voltage of the level that is higher than the first data voltage is determined so that the measurement voltage by the pixel current Ids is outputted so as to be larger than 0.1 V in the measurement of the second pixel current.

The SAR logic 640 repeats the measurement of the second pixel current by amending the second data voltage until there is no difference between the first amplification voltage VAMP1 and the second amplification voltage VAMP2, or until the difference value between the first amplification voltage VAMP1 and the second amplification voltage VAMP2 is a predetermined threshold value or less.

When there is no difference between the first amplification voltage VAMP1 and the second amplification voltage VAMP2, the second data voltage becomes the data voltage that reflects the image data compensation amount for compensating the characteristic deviation of the driving transistor M2a of the measurement pixel PXa. Accordingly, the SAR logic 640 can obtain the image data compensation amount of the measurement pixel PXa.

That is, the compensator 600 measures the first pixel current by applying the first data voltage to the measurement pixel PXa, and measures the second pixel current by applying the second data voltage that is obtained by modifying the first data voltage for compensating the characteristic deviation of the driving transistor M2a of the measurement pixel PXa, thus calculating the image data compensation amount.

Now, referring to FIGS. 1 to 4, the driving method of the display device will be described in detail. It is a process for compensating the characteristic deviation of the driving transistor of each pixel during the compensation period.

Referring to FIGS. 1 to 4, the voltage that turns on the first selection switch S1a, the second selection switch S2a, and the first reset switch SWa are logic high level voltage and the voltage that turns them off is the logic low level voltage. The voltage that turns on the switching transistor M1a of the measurement pixel PXa and the detection transistor M3a is the logic low level voltage, and the voltage that turns them off is the logic high level voltage. During the compensation period, the third selection switch S2b is maintained at a turn on state.

The measurement of the first pixel current is performed between T1 and T4.

Between T1 and T2, the initialization operation of the panel capacitor CLa is performed. The second selection switch S2a and the first reset switch SWa of the measurement pixel PXa are turned on and the first selection switch S1a is turned off.

If the first reset switch SWa is turned on, the output terminal of the first differential amplifier DAa and the inversion input terminal (−) are connected to each other to become the source follower. In this case, since the test data voltage VDX is inputted to the non-inversion terminal (+) of the first differential amplifier DAa, the test data voltage VDX is outputted to the output terminal. Since the output terminal of the first differential amplifier DAa is connected to an end of the first panel capacitor CLa, the first panel capacitor CLa is charged by the test data voltage VDX that is the output terminal voltage of the first differential amplifier DAa.

Between T2 and T3, the first selection switch S1a of the measurement pixel PXa is turned on, and the second selection switch S2a and the first reset switch SWa are turned off. The SAR logic 640 transmits the signal that generates the first data voltage to the converter DACa, and the converter DACa converts the signal that is from the SAR logic 640 into the first data voltage and transmits the first data voltage to the data line Dj of the measurement pixel PXa.

The scan signal SSa of the measurement pixel PXa is applied to the logic low level, thus turning on the switching transistor M1a. The first data voltage is transmitted through the turned on switching transistor M1a to the gate electrode of the driving transistor M2a, and the pixel current Ids flows to the driving transistor M2a.

Between T3 and T4, the first selection switch S1a of the measurement pixel PXa is turned off and the second selection switch S2a is turned on. The first reset switch SWa is maintained at a turn off state. The scan signal SSa turns off the switching transistor M1a by applying a signal at a logic high level, and the detection signal SESa turns on the detection transistor M3a by applying the signal at a logic low level. If the ELVDD voltage is applied to the cathode electrode of the organic light emitting diode OLED and the detection transistor M3a is turned on, the pixel current Ids flows to the measurement resistor RDDa.

The pixel current Ids charges the measurement capacitor CDDa, and is converted into the measurement voltage of RDDa*lds by the measurement resistor RDDa. The measurement voltage is inputted to the inversion input terminal (−) of the first differential amplifier DAa, and the first differential amplifier DAa outputs a difference between the test data voltage VDX and the measurement voltage RDDa*lds to the first amplification voltage VAMP1.

The target voltage VTRGT becomes the target value of the output voltage of the first differential amplifier DAa, is inputted to the non-inversion input terminal (+) of the second differential amplifier DAb, and the second amplification voltage VAMP2 is outputted in the output terminal. If the voltage difference between the test data voltage VDX and the measurement voltage RDDa*lds is the same as the target voltage VTRGT, the SAR logic 640 determines the compensation image data signal for compensating the characteristic deviation of the measurement pixel PXa. This value may be transmitted to the signal controller 100 or stored in the compensator 600.

If the voltage difference between the test data voltage VDX and the measurement voltage RDDa*lds is not the same as the target voltage VTRGT, the SAR logic 640 performs the measurement of the second pixel current to the second data voltage.

The measurement of the second pixel current is performed in the same manner as the measurement of the first pixel current. The initialization operation of the panel capacitor is performed, the pixel current is generated to the second data voltage, and the pixel current is converted into the measurement voltage to measure the pixel current. A detailed description of the second pixel current will be omitted.

In the measurement of the second pixel current, if a difference between the first amplification voltage VAMP1 and the second amplification voltage VAMP2 is not detected, the SAR logic 640 sets the second data voltage as the data voltage for compensating the characteristic deviation of the driving transistor M2a of the measurement pixel PXa and transmits it to the signal controller 100.

In the measurement of the second pixel current, if a difference between the first amplification voltage VAMP1 and the second amplification voltage VAMP2 is detected, the SAR logic 640 amends the second data voltage and re-measures the second pixel current as the third data voltage for compensating the characteristic deviation of the driving transistor M2a of the measurement pixel PXa. The SAR logic 640 repeats the measurement of the second pixel current until there is no difference between the first amplification voltage VAMP1 and the second amplification voltage VAMP2, or until the difference value between the first amplification voltage VAMP1 and the second amplification voltage VAMP2 is a predetermined threshold value or less. In addition, the SAR logic 640 can repeat the measurement of the second pixel current by the number of N.

In this case, in the measurement of each pixel, after the initialization operation of the first panel capacitor CLa is performed by turning on the first reset switch SWa and the second selection switch S2a, the measurement of the pixel current may be rapidly performed by measurement the pixel current of the measurement pixel PXa.

The above operation is performed in respects to all pixels, and the SAR logic 640 determines the compensation image data signal in respects to each pixel. That is, the SAR logic 640 can perform the measurement of the first pixel current and the second pixel current in respects to a plurality of pixels PX that are included in the display 400, and the compensation image data signal of each pixel PX can be determined through the measurement of the first pixel current and the measurement of the second pixel current. The SAR logic 640 transmits the compensation image data signal of each pixel PX to the signal controller 100. The signal controller 100 detects the compensation image data signal that corresponds to each input video signal, and this is transmitted to the data driver 300 as the image data signal DAT. The data driver 300 selects the data voltage according to the image data signal DAT and transmits the data voltage to the corresponding pixel.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A display device comprising:
a display including a plurality of pixels;
a compensator that for each of a plurality of pixels, generates a compensation image data signal that compensates a characteristic deviation of a driving transistor of each pixel by measuring the first pixel current generated by the first data voltage and the second pixel current generated by the second data voltage that is obtained by amending the first data voltage, and initializes a panel capacitor that is parasitic on a plurality of data lines connected to the plurality of pixels n the measurement of the first pixel current and the measurement of the second pixel current; and
a signal controller that generates an image data signal by reflecting a compensation amount of the image data.

2. The display device of claim 1, wherein the compensator includes:
a measurement portion that measures each pixel current of the plurality of pixels;
a target portion to remove noise that is generated at the measurement portion;
a comparison portion that compares output values of the measurement portion and the target portion;
a SAR (Successive Approximation Register) logic that calculates the image data compensation amount from an output value of the comparison portion; and
a converter that converts the output value of the SAR logic to an analog value and transmits the value to the plurality of pixels.

3. The display device of claim 2, wherein the measurement portion includes:
a measurement resistor that converts each pixel current of the plurality of pixels into a measurement voltage;
a differential amplifier that outputs a difference between a predetermined test data voltage and the measurement voltage; and
a reset switch that is connected to the measurement resistor in parallel to initialize the panel capacitor.

4. The display device of claim 3, wherein the differential amplifier includes:
a non-inversion input terminal to which the predetermined test data voltage is inputted;
an inversion input terminal that is connected to the plurality of data lines; and
an output terminal that outputs a difference between the predetermined test data voltage and the measurement voltage.

5. The display device of claim 4, wherein the reset switch includes:
an end that is connected to the output terminal of the differential amplifier; and
another end that is connected to the plurality of data lines.

6. The display device of claim 4, wherein measurement resistor includes:
an end that is connected to the output terminal of the differential amplifier; and
another end that is connected to the plurality of data lines.

7. The display device of claim 3, wherein:
the reset switch is turned on before the pixel current is measured, such that the differential amplifier becomes a source follower.

8. The display device of claim 7, wherein:
the compensator charges the panel capacitor with the predetermined test data voltage by turning on the reset switch, thus performing initialization.

9. The display device of claim 2, wherein:
the target portion is connected to the reference pixel that has a predetermined reference threshold voltage and reference mobility to obtain the same configuration as the measurement portion.

10. The display device of claim 2, wherein the comparison portion includes:
a non-inversion input terminal to which an output voltage of the measurement unit is inputted;
an inversion input terminal to which an output voltage of the target portion is inputted; and
a differential amplifier that includes an output terminal for outputting a difference between the output voltage of the measurement unit and the output voltage of the target portion.

11. The display device of claim 2, further comprising a data selector, the data selector including:
a first selection switch that connects the plurality of pixels to the converter; and
a second selection switch that connects the plurality of pixels to the measurement portion.

12. A driving method of a display device, the method comprising:
initializing a panel capacitor by charging the panel capacitor that is parasitic on a data line that is connected to a pixel by a test data voltage;
generating a first pixel current by applying a first data voltage to the pixel;
measuring the first pixel current by changing the first pixel current to a measurement voltage; and
generating a second pixel current by applying a second data voltage, compensating a characteristic deviation of a driving transistor of the pixel, that is obtained by modifying the first data voltage to the pixel; and
measuring the second pixel current by changing the second pixel current to the measurement voltage.

13. The driving method of claim 12, further comprising:
after the second pixel current is measured, generating a compensation image data signal that compensates the characteristic deviation of the driving transistor of the pixel.

14. The driving method of claim 13, further comprising:
transmitting a data voltage selected according to the compensation image data signal to the pixel.

15. The driving method of claim 12, further comprising:
charging the panel capacitor with the test data voltage before the second pixel current is generated.

16. The driving method of claim 12, wherein:
the generating the first pixel current includes
turning on a first selection switch to connect a converter to which the first data voltage is outputted and the pixel; and
turning off a second selection switch to connect a measuring portion that measures the first pixel current and the pixel.

17. The driving method of claim 12, wherein:
the measuring of the first pixel current includes
turning off a first selection switch to connect a converter to which the first data voltage is outputted and the pixel; and
turning on a second selection switch to connect a measuring portion that measures the first pixel current and the pixel.

18. The driving method of claim 12, wherein:
the panel capacitor is connected to the output terminal of a differential amplifier to which the test data voltage is inputted,
the initializing panel capacitor makes the differential amplifier as a source follower by turning on a reset switch that is connected in parallel to a measurement resistor that converts the first pixel current into the measurement voltage.

19. The driving method of claim 18, wherein:
the reset switch keep turned off in the measuring the first pixel current and in the measuring the second pixel current.

20. A display device comprising:
a display including a plurality of pixels;
a compensator calculating an image data compensation amount that compensates a characteristic deviation of a driving transistor of each pixel by measuring the first pixel current generated by the first data voltage and the second pixel current generated by the second data voltage obtained by amending the first data voltage, and initializing a parasitic panel capacitor on a plurality of data lines connected to the plurality of pixels according to the image data compensation amount; and
a signal controller generating an image data signal in accordance with the image data compensation amount.

21. The display device of claim 20, wherein the compensator includes:
a measurement portion to measure each pixel current of the plurality of pixels;
a target portion to remove noise that is generated at the measurement portion;
a comparison portion to compare output values of the measurement portion and the target portion;
a SAR (Successive Approximation Register) logic to calculate the image data compensation amount from an output value of the comparison portion; and
a converter that converts the output value of the SAR logic to an analog value and transmits the analog value to the plurality of pixels.
